(19) United States
(12) Patent Application Publication
(10) Pub. No.: US 2008/0013916 A1
(43) Pub. Date: Jan. 17, 2008

(54) SYSTEMS AND METHODS FOR ENCODING, EDITING AND SHARING MULTIMEDIA FILES

(75) Inventors: Kathy Lynne Sharpe, New York, NY (US); Lucas Monaco, Brooklyn, NY (US); Matthew Belanger, New York, NY (US)

Correspondence Address: KALOW & SPRINGUT LLP, 488 MADISON AVENUE, 19TH FLOOR, NEW YORK, NY, 10022, US

(73) Assignee: VideoThang LLC, New York, NY (US)

(21) Appl. No.: 11/767,103

(22) Filed: Jun. 22, 2007

Related U.S. Application Data
(60) Provisional application No. 60/831,392, filed on Jul. 17, 2006.

(51) Int. Cl. H04N 5/93

(52) U.S. Cl. 386/52; 386/E05.028

(57) ABSTRACT

The present invention is directed to computer based editing systems, methods for editing videos, methods for communicating from server to the desktop and computer readable storage media that are capable of executing certain methods and applying certain video editing systems. Through the use of the present invention one can efficiently combine a plurality of media elements that are in a plurality of different forms into one video. In certain embodiment, the invention couples an editing tool with a channel that communicates to a server in a format that is downloaded from a server that may or may not be the server with which it continues to communicate. That channel can deliver live updatable multi-media formats e.g. text, flash, gifs. to the editing tool whenever the user is online.

### CROSS-REFERENCE TO RELATED APPLICATION

This application claims the benefit of the filing date of U.S. Provisional Application Ser. No. 60/831,392, filed Jul. 17, 2006, the entire disclosure of which is incorporated by reference as if set forth fully herein.

### BACKGROUND OF THE INVENTION

Many people enjoy viewing motion pictures. However, they often feel detached from the experience and would prefer to have their video experiences be more participatory processes. The recent proliferation of affordable video-recording devices, particularly digital recording devices that generate videos capable of being edited, has increased the demand for affordable and accessible video-editing strategies. Through the use of a suite of motion picture players, mixers and editors that encourage the viewer to become more active in the experience of motion picture based media, the marketplace has enabled amateur video artists to have richer experiences and to develop new narratives.

However, known systems for video editing suffer from one or more of a number of drawbacks. First, as system designers have sought to offer more functionalities, they often increase levels of complexity, thereby rendering products less user friendly. Moreover, because of the increased complexity, consumers are often unable to avail themselves of some of these products' most impressive features. Second, certain products are limited in their compatibility with many of the formats in which videos are taken and stored. Third, many products are limited in their use because they are not easily accessed or shared by multiple users. Exemplary existing products include but are not limited to eyespot, jumpcut, wmm, Imovie and Adobe AfterEffects.

Because of these limitations, many potential amateur video artists do not avail themselves of the opportunity to participate in the video editing experience. Thus, there is a need to develop a user-friendlier video editing system that is compatible with many formats and allows for sharing of videos.

### SUMMARY OF THE INVENTION

The present invention is directed to personal computer based editing systems, methods for editing videos, methods for communicating from server to the desktop and computer readable storage media that are capable of executing methods and video editing systems. In certain embodiments, the present invention couples an editing tool with a channel that communicates with a server in a format that permits downloading from a server. The server with which the channel communicates may or may not be the server from which the editing system was obtained. The channel can deliver live updatable multi-media formats e.g. text, flash, gifs. to the editing tool whenever the user is online.

In certain embodiments, the present invention is directed to a method in which a user downloads a multimedia editing system via a network such as the Internet that runs on a user's computer to allow the user to encode existing multimedia, to edit encoded multimedia, to create new multimedia files out of existing files in a given format for use on other computers, and to share the new files with others via a network or the Internet. Various embodiments of the method include the ability to manipulate the visual and audio elements of the multimedia files to the user's specifications. Some embodiments of the method include the ability to detect the presence of Internet connectivity and to provide the ability to communicate with a server if requested by the user. The communications may include authentication elements, advertisements, or other types of information. Within the system, there may also be a channel for receiving and displaying a content that is received from a remote server and/or stored locally within the editing system.

The present invention is also directed to systems, methods and computer readable storage media that allow for the combination and manipulation of media elements (including, but not limited to video, audio visual and visual elements) to create new videos. The media elements may be taken from one or more sources, put into a standardized format, edited and saved or shared through the use of an integrated application.

In various embodiments, a computer-based video editing system having a user interface is provided. The computer-based video editing system may comprise: (a) an import module for importing and/or uploading one or more media elements and converting said one or more media elements into a standardized digital editing format; (b) an edit module coupled to the import module for editing the one or more media elements when in said standardized digital editing format to form an edited video; and (c) a share module coupled to the edit module for exporting the edited video to a user specified destination, wherein the import module, the edit module and the share module are accessible from said user interface. In some embodiments, the editing system made be combined with or include a channel module that permits display of additional multimedia files that are provided from a remote server or stored locally, including but not limited to advertisements and promotions. These elements that are transmitted through the channel may be displayed on the same interface through which the aforementioned edit module is visible.

In various embodiments, a method for editing videos is provided, comprising: (a) accessing a user interface, wherein said user interface provides access to an import module, an edit module and a share module, wherein said edit module is coupled to said import module and said share module; (b) importing one or more media elements in a first format and converting said one or more media elements into a standardized digital editing format, wherein said importing and converting are initiated by activating said import module; (c) editing said one or more media elements by using said edit module, wherein said editing occurs while said one or more media elements are in said standardized digital editing format to form an edited video; and (d) sharing said one or more media elements by using said share module to convert said edited video into a user specified format and sending said edited video in said user specified format.

In various embodiments, a computer readable storage medium for storing instructions is provided that when executed by a computer, causes the computer to access a computer-based video editing system. The computer-based video editing system comprises: (a) an import module for importing one or more media elements and converting said one or more media elements into a standardized digital editing format; (b) an edit module coupled to the import module for editing said one or more media elements when in said standardized digital editing format to form an edited video; and (c) a share module coupled to the edit module for exporting said edited video to a user specified destination, wherein said import module, said edit module and said share module are accessible through the same interface.

The various embodiments of the present invention may be used by both video professionals and lay persons to create edited videos. Applications of the invention include but are not limited to creating: edited videos of home movies of children, weddings, parties, graduations and sporting events; video presentations for marketing or teaching; and multimedia presentations by students and professionals.

### BRIEF DESCRIPTION OF THE FIGURES

FIG. 1 is a representation of the components of a user interface of an embodiment of the present invention.

FIG. 2 is a flowchart representation of how a user may use an embodiment of the present invention.

FIG. 3 is a representation of an exemplary architecture of an embodiment of the present invention.

FIGS. 4a, 4b and 4c are screen shots of exemplary interfaces of three embodiments of the present invention.

FIG. 5 is a representation of the save movie feature an embodiment of the present invention.

### DETAILED DESCRIPTION OF THE INVENTION

Definitions

As used herein and unless otherwise indicated by context, the terms and phrases identified below have the meanings provided. Further, when terms and phrases are used that refer to commercial products, the present invention is understood as applying to other products and applications with similar features.

The term “ActiveX” refers to software components from Microsoft. They enable sound, Java applets and animations to be integrated in a web page.

The phrase “application programming interface” and the acronym “API” refer to a source code interface that a computer system or program library provides in order to support requests for services to be made of it by a computer program.

The term “channel” refers to an alert module that may be part of the computer-based video editing system of the present invention. The channel may be configured to receive communications and be coupled to the edit module, such that a user may be notified of a preprogrammed event or contacted by another individual or entity during editing. Thus, the channel may offer a dedicated location for content including but not limited to text, graphics, video, audio delivery from and transmission to any pre-determined location on e.g., the Internet. Examples of content include but are not limited to advertisements, promotional information, requests for information and requested information.

The phrase “connection method” refers to an interface method object that provides a way to exchange complex data between multiple interface instances.

The phrase “editable element” refers to a media file as it is used within the application.

The phrase “editable format” refers to a file format that provides an interface whereby the interface method or another program can modify the file. The editable format is advantageous in connection with the present invention because it enables higher quality playback of video, and better access to video and audio properties. A non-limiting example of an editable format is FLV, which refers to Flash video file format.

The abbreviation “EDL” refers to an edit decision list, which is a list of commands and/or properties used to display, manipulate, revise or play a movie.

The phrase “edited output file” refers to the file produced by an application after the user has manipulated, combined, edited or otherwise changed or modified one or more videos that have been imported. The form that it may take includes, but is not limited to slideshows with or without sound, videos with or without sound, animation sequences with or without sound, and sound sequences with or without visuals, as well as combinations of these formats.

The term “file system” refers to a method for storing and organizing computer files and the data they contain to make them easy to find and to access them. File systems may use a storage device such as a hard disk or CD-ROM and involve maintaining the physical location of the files, or they may be virtual and exist only as an access method for virtual data or for data over a network.

The acronym “FTP” refers to a file transfer protocol.

The phrase “FTP client” refers to software that utilizes FTP.

The acronym “GUI” refers to a graphical user interface.

The phrase “hypertext transfer protocol” and the acronym “HTTP” refer to the set of rules for exchanging files (text, graphic images, sound, video and other multimedia files) on the world wide web.

The phrase “host application” (e.g., Real Basic) refers to the “shell” or “wrapper” application that is running on a user's computer.

The phrase “input device” refers to any device from which a user may edit the one or more media elements or any device from which the user may upload or import media elements or other images or text that may be incorporated into the media element, and may comprise a graphic user interface. Examples of input devices include but are not limited to a personal computer, a digital camera, a touch activated video or television screen, a camcorder and a cellular telephone.

The phrase “import file” refers to a series of events that enables a user to edit the chosen file through the interface method.

The phrase “input format” refers to the format of a file before the file is brought into an application. Exemplary input formats include but are not limited to text, GIF, SWF and AVI.

The phrase “integrated application” as used herein refers to an application that is at least in perception nested within or a child of another application. Thus, it may refer to an application that launches within the current application, to possibly perform separate duties, such as sharing, emailing, etc.

The phrase “interface method” refers to a method whereby a user of a computer can interact with visual elements on the screen. The method can provide feedback from the computer, as well as store information received from or generated by the user. The interface method also provides a platform on which to display various media types such as images, audio, graphics, and movies. The interface method is advantageous in connection with the present invention because it enables the editor module to take advantage of its ability to manipulate visual and audio files for playback. A non-limiting example of an interface method is Flash, which is also referred to as Adobe Flash. When the interface method's player executes its play command, it runs through a sequence of commands chosen by the user to make up the edited output file. Through a loader, the interface method import the target files. A loader may for example, operate through a movie load method or a movie object method.

The phrase “master interface method file” refers to a file that is hosted by the application, through e.g., a browser or other software running on a computer.

The phrase “media conversion method” refers to a method whereby a given file on a personal computer can be converted from one format to another, or a copy of the given file can be created in a second format. The method can be an application that can convert multimedia files from one format to another and execute basic editing commands using for example, known codecs. A non-limiting example of a media conversion method is the method employed by FFMPEG. A media conversion method takes argument that can determine how to change numerous properties of the output file(s). Simply calling the media conversion method with the proper arguments, specifying input and output files does this. The media conversion method is advantageous for us in connection with the present invention because it transcodes audio/visual fields to a format that the interface method can manipulate. It also may enable capturing of the playback to the file system.

The phrase “media file” refers to a video, image, audio or other file that is defined as acceptable to an application as it is used within the application.

The phrase “metadata insertion method” refers to a method that reads a video file and puts duration information into it. It requires input and output filenames, and arguments to determine what to do with them. It may be used to inject metadata into the file, which a user can later access. The metadata insertion method may be advantageous for use in connection with the present invention because it enables access to certain audio/visual properties, thereby enabling more advanced editing. Non-limiting examples of the metadata insertion method include FLVTool and FLVTool2.

The phrase “movie object” refers to a data type of the interface method.

The phrase “multimedia file” refers to a video, image or audio file.

The phrase “Nullsoft Scriptable Installer” refers to a software application that enables compression and extraction of files for installation on a computer.

The term “On2” refers to a commercial application that can convert multimedia files from one format to another and execute basic editing commands, as well as perform other operations.

The phrase “output format” refers to the format of a file after it has been modified by an application. Exemplary output formats include but are not limited Microsoft Word, Acrobat/PDF, text and html.

The phrase “peer-to-peer” (or P2P) as used herein and as described by wikipedia refers to a computer network that “is a network that relies primarily on the computing power and bandwidth of the participants in the network rather than concentrating it in a relatively low number of servers. . . . A pure peer-to-peer network does not have the notion of clients or servers, but only equal peer nodes that simultaneously function as both ‘clients’ and ‘servers’ to the other nodes on the network. This model of network arrangement differs from the client-server model where communication is usually to and from a central server.”

The phrase “remote server” refers to a computer other than the one running an application. A remote server may for example be accessible through the Internet.

The phrase “runtime executable” refers to a file whose contents are meant to be interpreted as a program by a computer.

The phrase “SMIL format thumbnail” refers to an image formatted by the Synchronized Multimedia Integration Language.

The term “SSL” refers to secure sockets layer, a protocol developed by Netscape for transmitting private documents via the Internet. SSL works by using a private key to encrypt data that's transferred over the SSL connection.

The phrase “standardized digital editing format” may be any format that allows for easy manipulation by a desired application. Examples of types of files that may be imported and converted include but are not limited to WMV, AVI, MPEG, Quicktime, FLV, JPEG and MP3. The files may, for example, be converted to the editable format via the media conversion method though e.g., On2 or other technology. These conversion applications enable a user to convert media files including but not limited to images and/or audio into a workable and editable format.

The term “timeline” refers to a conceptual grouping of one or more multimedia files, their properties, and/or effects and/or transitions. A timeline may for example be created by: (i) clicking and dragging media to a “timeline places media” location within the timeline; (ii) clicking an “add media to timeline” button, which also places media within the timeline; and (iii) loading playback values such as begin and end and any other effect(s).

The phrase “video library” refers an archive of videos that a user may access in order to create the edited video. The phrase “media library” refers to an archive of media elements that may or may not include videos that a user may access to in order to create the edited video.

The acronym “XML” refers to a XML (extensible markup language) and is a W3C initiative that allows information and services to be encoded with meaningful structure and semantics that computers and humans can understand.

The phrase “XML file” refers to a text file containing text formatted according to the XML specification (http://www.w3.org/TR/REC-xml/).

The phrase “XML load method” refers to an interface method object that manages the opening and parsing of XML.

The phrase “XML load object” refers to an interface method object type that is created by the XML load method.

### Preferred Embodiments

According to a first embodiment, the present invention is directed to a computer-based video editing system that has or accesses a user interface. The user interface may be accessible from any computing device that is now known or that comes to be known and that a person of ordinary skill would appreciate as being useful with the present invention. Exemplary user interfaces include but are not limited to graphic user interfaces displayed on personal computers, cellular telephones, kiosks, screen phones, television screens if appropriately configured with touch activated capabilities or other input devices such as keyboards for remote control, and portable wireless devices such as Palm Pilots and Blackberries that have sufficient power and resolution. In various embodiments, the user interface comprises both a viewing screen and one or more input devices such as a computer keyboard, computer mouse or touch screen.

The computer-based video editing system preferably comprises an import module, an edit module and a share module. These three modules are coupled to one another and are accessible through the user interface. As used herein, the phrase “coupled to one another” means that after accessing the video editing system, a user may access any one or more of the three modules in any sequence without opening or closing different programs. The modules may comprise one or more hardware, software, or hybrid components residing in or distributed among one or more local or remote computers. The modules may be physically separated or together and may each be a logical routine or part of a logical routine that carries out the embodiments disclosed herein.

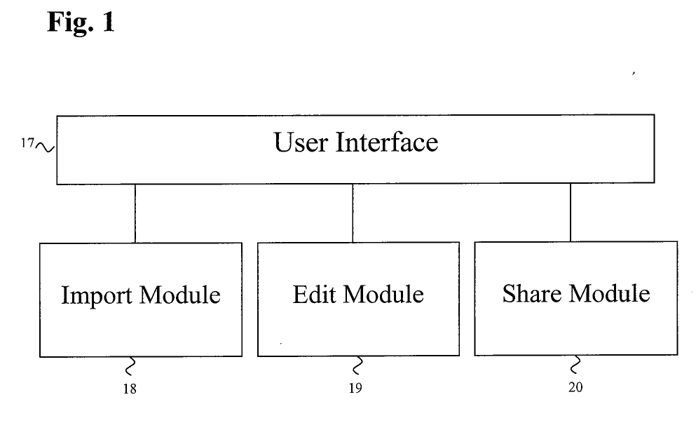

As FIG. 1 shows, the three modules may be accessible through the same user interface, 17. More preferably, the interface presents an icon or text representative of each of the three modules on a screen at the same time. A user may for example, access any one of the modules through the use of a computer mouse to drag an arrow or other icon displayed on a computer screen. Any or all of the modules may be located on a stand-alone computer system or may be accessible through a web browser over a network such as the Internet. Although the editing system may be obtained from a remote server, the editing system is preferably downloaded to a local computer and run on the local computer. By downloading to a local computer, a user may use the application regardless of whether on-line.

The import module, 18, is designed for importing one or more media elements and converting said one or more media elements into a standardized digital editing format. The user may activate the import module through for example a single “click” and be able to initiate both the importing and converting functions. A “media element” is any combination or recording of video elements, e.g., images recorded by a video camera. The images are in digital form when imported. The term imported is used interchangeably with the terms “transcoded” and “converted.” If images are in analog form, a user may first convert the analog images into digital format.

The import module is also capable of importing individual photos, individual graphics, animation, text files, etc. Applications for importing files are well known, and include but are not limited to Microsoft's Windows applications and applications of competitors that provide similar capabilities, including, but not limited to, DivX, On2 Flix?, Riva FLV Encoder and VIDEOzilla 2.5. Prior to importing, the media elements may be in any format that is capable of being converted into a standardized digital editing format. However, prior to being acted upon by the edit module, the media elements are converted into the standardized editing format.

The edit module, 19, is coupled to the import module and accessible through the user interface. The edit module may be used for editing one or more media elements. The media element that is created after editing may be referred to as an edited element such as an edited video element.

Preferably the edit module comprises means to combine imported media elements, to manipulate the images and to alter the images. For example, the edit module may comprise one or more, and preferably, all of the following means to edit the one or more media elements: linking two more or more videos together (via for example a timeline), adding an audio overlay, inserting a title sequence, cropping video segments, digitally altering the size of video segments, altering the color of video segments, inserting text, adding special effects (such as sounds and bursts of light) and inserting videos within videos. Thus, in a simple case two media elements are uploaded and dragged to a video timeline in the order desired by a user. A title may be inserted at the start of the first media element and fade out and fade in effects may bridge the two sequences. The use of timelines in digital video editing is well known to persons of ordinary skill in the art, and includes for example, the AVID/1 Media Composer from Avid Technology, Inc. of Tewksbury, Mass., Adobe Premiere Pro., Final Cut Pro HD, and Sony Vegas 5.

The share module, 20, is also accessible through the user interface and is coupled to the edit module for exporting said edited video to a user specified destination. Examples of user specified destinations include but are not limited to a hard drive, a web-site, one or more e-mail accounts and a cellular telephone. Further, the system may allow for peer-to-peer sharing.

The system may optionally have a default position that is supplied by the user, instituted system-wide or assumed to be the same as the source of the video editing system. Thus, a user may edit the file while the file is in a format such as the editable format saving the information and associated data as for example XML data, and then export through a file format such as the editable format to the user specified destination.

As noted above, the import module, the edit module and the share module are accessible from said user interface. This is beneficial because it makes it easier for the user to share edited videos quickly and without being forced to execute additional applications, or to have knowledge of those applications.

The computer-based video editing system may further comprise (or be coupled to) an input device. A user may import and edit from the same input device. Alternatively, a user may import from one device (e.g. a digital camera connected to a USB port) and edit through a separate device such as a computer keyboard.

According to some embodiments, a user accesses the import module, the edit module and the share module over the Internet. Thus, the input device may be remote from the other components of the video editing systems. Alternatively, the import module, the edit module and the share module could already be located on the hard drive of a personal computer or on a LAN network. These modules may all be downloaded from the Internet or installed off of an electronic storage device.

The computer-based video editing system may also comprise (or be coupled to) a video library. Preferably, this video library is accessible from the import module. The video library may be located on the user's hard drive, a portable memory stick, a CD, a DVD, the world-wide-web or a remote server. Further, the computer-based video editing system may comprise a number of video libraries that are located in the same or different locations.

The edit module of the computer-based video editing system may function in an integrated development environment. Integrated development environments may contain one or more of a number of components, including a source code editor, a compiler and/or interpreter, and a build-automation tool. Optionally, they may also comprise a debugger.

According to some embodiments, the computer-based video editing system does not comprise a toolbar. In these embodiments there are simple icons on the screen that enable a user to activate a particular module. In certain of these embodiments all of the edit features described above are also similarly accessible from the same interface as the import module and the share module. Similarly, the different destinations may also be accessible from that interface.

As noted above, a user may access the computer-based video editing system on an individual personal computer, through a local area network (LAN) or remotely over, for example, the Internet. Similarly, the computer-based video editing system itself can be configured to access one or more remote servers. When one or more remote servers are accessed, a plurality of users can work jointly on a video, and any user may send the finished or unfinished video to any one or more recipients. Similarly, the system may be configured such that only the recipients have access to the finished work, either by being sent the work via e-mail or notification of its completion via e-mail, text message or other means, and being granted rights to see only a finished product. The finished work may also be sent to television or video screens if the appropriate configurations exist.

Sharing may take place in a number of ways. For example, via e-mail, the application would have an interface consisting of input fields: of “from” address, “to” address(es), subject, body, and send button. This application may access its own mail software, accessing common ports and protocols for sending mail.

By way of another example via upload to a user's site, the application would have an interface consisting of input fields of: ftp address, username, and password. The application would access its own ftp software, accessing common ports and protocols for ftp.

By way of a third example via upload to an existing community site or blog, the application would have an interface consisting of input fields compliant with existing community site's API, such as Blogger API (www.blogger.com/developers/api/1_docs) TypePad, and Veoh etc.

Technologically, the video editing system could reside in whole or in part on a server. This would be advantageous when remote users wish to work on a video at the same time, and/or when a user has limited storage capabilities. However, as noted above, in certain applications, it is advantageous for the user to have the application reside locally on e.g., her hard drive, both for privacy and for convenience of use when access to the server is not feasible.

According to another embodiment, the present invention is directed to a method for editing videos. This method comprises first accessing a user interface through, for example, a computer screen or interactive television screen. The user interface provides access to an import module, an edit module and a share module. The edit module may be coupled to said import module and said share module. The coupling can be wired or wireless and the modules can be part of the same device or logic routine.

After accessing the user interface, the user may import one or more media elements while in a first format and convert said one or more media elements into a standardized digital editing format, wherein said importing and converting are initiated by activating said import module. The user may also then edit the one or more media elements by using said edit module, wherein said editing occurs while said sequences are in said standardized digital editing format to form an edited video. Finally, the user may share said one or more media elements by using the share module to convert the editable element into a user specified format and export the video in said user specified format. The conversion of elements into a user specified format may, unless otherwise specified be accomplished by converting the editable elements themselves directly into the user specified format, or by obtaining the constituent properties of the editable elements and converting the portions of the initial media elements from the form in which they were originally stored or imported by the user. Thus, if two original elements are in JPEG and GIF forms and converted to the editable form of Flash to form the edited video, the properties can be read from the Flash file, and those properties can be used to pull the appropriate portions of the JPEG and GIF files and convert those portions of the JPEG and GIF files as defined by the properties into the new uniform output file that is saved and may be shared.

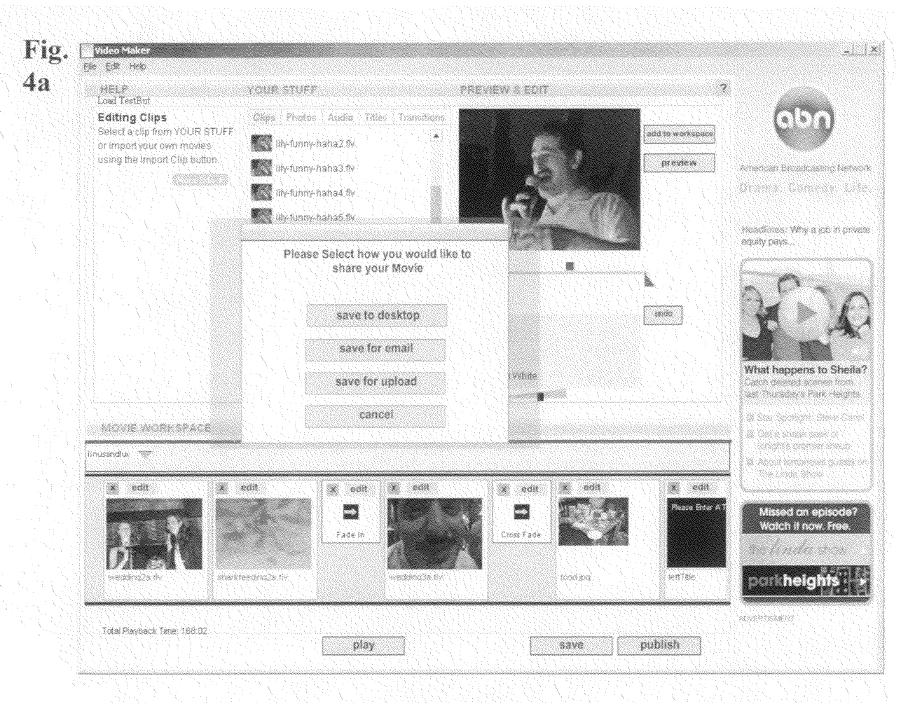

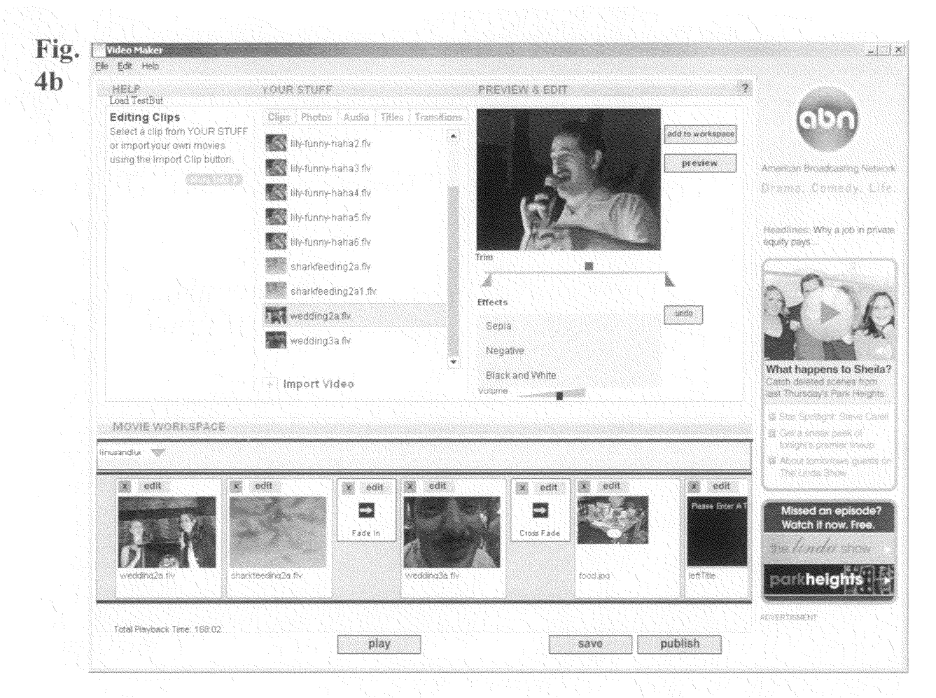

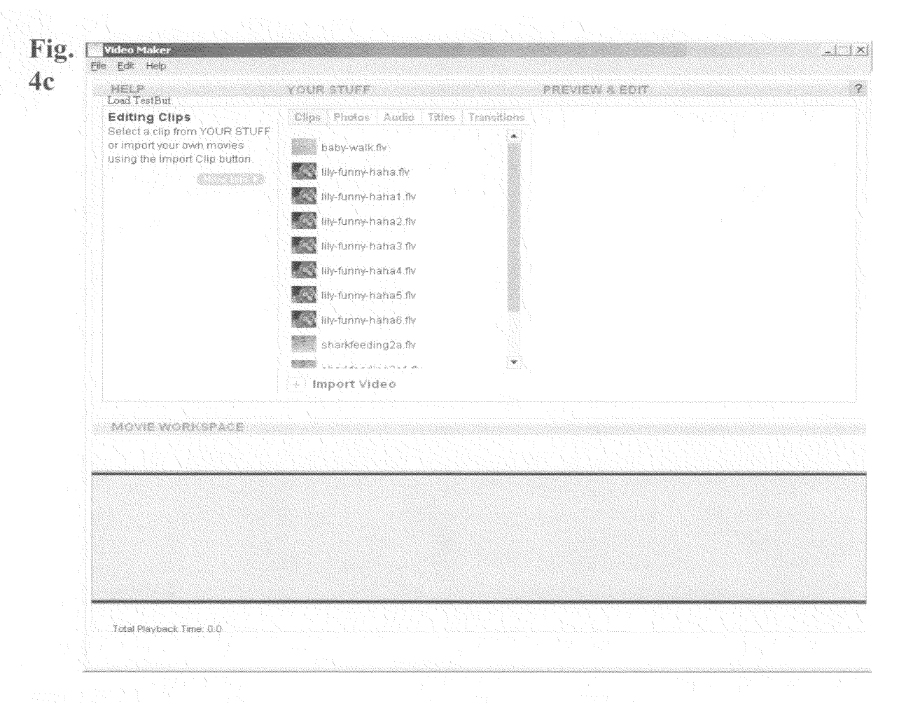

As with the first embodiment, the accessing may, for example, be through one or more input devices including a computer, a camera, a touch activated screen, a camcorder and a cellular telephone. Also as with the embodiments described above, the user interface may comprise icons through which to access the import module, the edit module, and the export module. Exemplary display screens for user interfaces are shown in FIGS. 4a-4c. FIG. 4a shows an interface with a channel. In FIG. 4a, there is a dialog bog asking the user to “Please Select how you would like to share your Movie,” and providing options of (i) save to desktop; (ii) save for email; (iii) save for upload; and (iv) cancel. In the lower portion of the screen (the movie workspace) is a timeline representing the videos that have been combined and certain media elements such as fade in and cross fade. On the right hand side there is a channel through which notification of e.g., a television show is advertised.

FIG. 4b is similar to FIG. 4a, except the dialog box is no longer present, and in the upper left box of the interface one can see an index of the clips of a particular user. To the right of the index is a preview and edit area in which a user can view a particular video segment, add effects, such as shortening the video; converting to black and white, sepia or negative; and adjusting the volume.

FIG. 4c depicts an interface of the present invention as it might look without a channel and before a user selects a clip to preview and to edit, and before she moves any clips to the movie workspace.

The user may also import media from, for example, a video library or an input device or other device that contains the desired image(s). These images may be located on a device or storage medium that is proximal to the user or remote, and accessible over the Internet or other network. Upon importing, the system accessed by the user will convert the media from its existing format into a standardized editing format. The user may then access the edit module and use any of the editing functions described in connection with the first embodiment. Alternatively, she may import and convert one or more additional media elements.

Upon completion of the video, the user may share the images to any one or more destinations such as her own hard drive, a portable device, an e-mail account or within a file accessible through the video editing system. The share module may also be referred to as an export module. During sharing or exporting the edited video may be converted into the user specified format, which as noted above may be the same as or different from the first format.

If the system is suitably designed, the user may also notify one or more recipients of the existence or the preparation of an edited video. The notification may be sent at the time that the user logs on, prior to importing and converting; after importing and converting but prior to editing; during editing; and/or after editing. The notifications may be sent via any means that are now known or that come to be known and that would appear useful in connection with the present invention, e.g., instant messaging, text messaging or e-mail with or without the video attached. A user may initiate the notification on a case-by-case basis or the system may contain a notification default such that every time a user logs on, a class of recipients is notified. The latter options may be beneficial when, for example, it is desired to monitor children, students, or employees.

According to another embodiment, the present invention is directed to a computer readable storage medium for storing instructions. When executed by a computer, the computer readable storage medium causes the computer to access a computer-based video editing system, which may be stored remotely and thus accessed over the Internet or locally, for example on the hard drive. In one embodiment, the computer-based video editing system comprises: (a) an import module for importing one or more media elements and converting the one or more media elements into a standardized digital editing format; (b) an edit module coupled to the import module for editing the one or more media elements when in the standardized digital editing format to form an edited video; and (c) a share module coupled to the edit module for exporting the edited video to a user specified destination. These modules are also preferably all accessible from the same interface.

Additionally, the computer storage medium of this embodiment also may contain instructions that affect the options and results of the other embodiments described above.

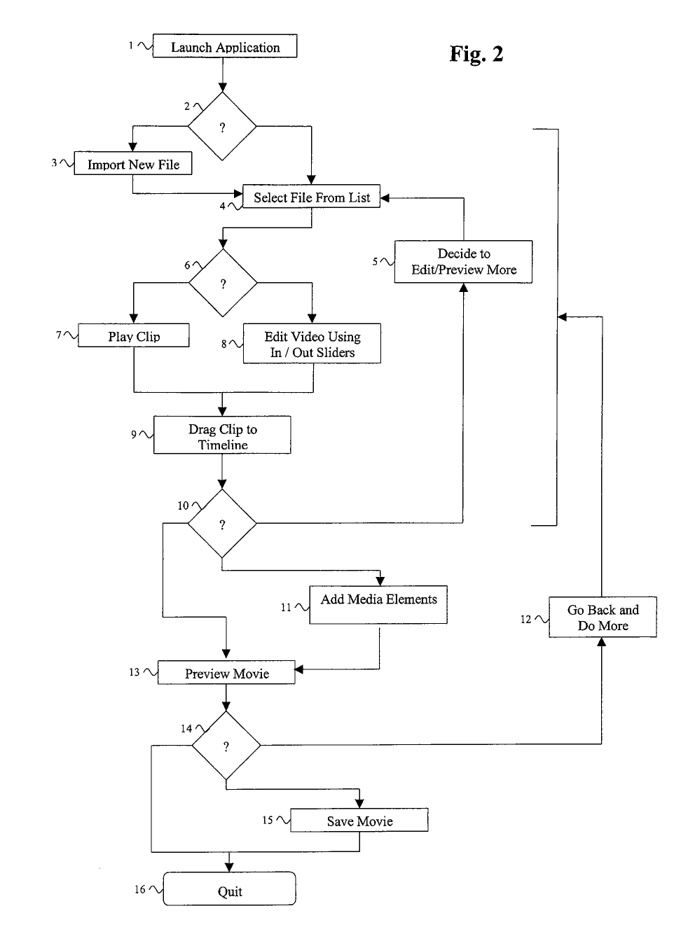

A non-limiting application of the present invention may be further appreciated by reference to FIG. 2. As FIG. 2 represents, a user may launch the application 1 from, for example, a personal computer connected to a remote server. By way of example, the application may be launched using the host application. During the launch, the application will check for dependencies, read the directory, write XML and load interface file(s) (graphic user interface).

The tasks for each application launch may include (1) authentication—authenticate application via internet connection or existing valid license on a personal computer against a) valid user/password, or b) valid computer, etc.; and (2) personalization—load any and all relevant files from a previous sessions with application or local (default) directories. What constitutes a relevant file will be based on preferences changed at last user session. XML is one example of a format that the application can use to store and retrieve these preferences, their details, and their dependencies.

During the launch, a program such the interface method may be loaded, which would load a file such as an XML file and display thumbnails from the system. The thumbnails would provide access to the various modules.

From the user's perspective, clicking on an icon on a desktop may most easily launch the application. Alternatively, the user may access a website and click on the icon within that website. As noted above, the application may reside on a local computer or on a server. When it resides on a local computer, the application may be configured to operate exclusively locally or to maintain connections to the Internet.

The user may then make decision 2 to either import a new file 3 or directly select a file from a list of available files 4. Importation may for example be called from a program such as interface method (e.g., Flash) or from the host application. When the importation is through the host application, the application may, for example, launch a choose dialog function, read in the file, check for acceptability of the format, determine an output name based on a naming conversion and the use of names by existing files and call a file based on that naming conversion. Another application (e.g. the media conversion method), may open the requested file and test its format against the list of accepted formats, and return a corresponding message to the host application, identifying the location to be saved, and how the naming conventions are determined or are defined within the host application software. The file may then set parameters, including the prescribed output format, e.g., the editable format, the audio output, e.g., mp3, the resolution e.g., 640×480 pixels, the frame rate, e.g. #Hz, the name and the location. A thumbnail may then be created and displayed on the interface. Subsequently, an application may be called, to inject meta data, e.g., duration. An exemplary application is the metadata insertion method.

The new file may for example be located on the user's hard drive or a removable device such as a video camera or videophone or a remote database such as a video library. The new file may then be added to list of available files and selected. If there is a pre-existing list of files associated with a user, these files may be collected and stored in a user's account, then after launching, the user may directly select the file from that list. Preferably, by the time that the file is in the list of selectable files, it is already converted into a standardized digital format. The file may be selected through, for example, application such as the interface method that loads the requested file from the system into the editable element preview area.

After the user selects a file, she may make another decision 6, either to play the editable element 7 or to edit the editable element using, e.g., in/out sliders to change the size or duration of the editable element 8. The editable element may, for example, be played following the execution of the interface method. Similarly, the in/out sliders may be used through the interface method. The editable element may then be dragged to a video timeline 9, by for example, the use of a computer mouse through an appropriate application such as the interface method. By dragging the editable element to the video timeline it may be combined with other editable elements in whatever orders the user desires. Further, when a plurality of editable elements is on the timeline, their sequence can be rearranged. When the selected media element or editable element is placed into the timeline, playback values may also be loaded into the timeline.

While the editable element is in the timeline the user may decide 10 to edit/preview more editable elements 5, and then select another file from the list of available files 4. She may also add media effects to the timeline 11 such as voice over, titles, captions, inserting editable elements between editable elements, animation, etc. The effects may be bridges between two video clips or over part of an editable element. During all edits, playback values are loaded into the timeline. The editing may be accomplished through use of an appropriate application, e.g. the interface method. The user may choose: (i) to import one or more images and then add them to the timeline; (ii) to zoom in or crop the image; (iii) to add one or more audio files; (iv) to crop the beginning and/or end of the audio file; (v) to add one or more titles and/or type words into the title; and/or (vi) to add the titles to the timeline and/or rearrange any of the elements and/or re-edit any of the elements of the timeline.

The user may also decide to preview the editable element 13 without editing it or without editing further if editing has already taken place and then decide 14 to save the editable element 15 for editing at a later time, or go back and do more importing and/or editing 12. During preview, the edit area may be hidden from view and the editable element may be loaded into a movie preview area. Alternatively all views of the initial interface may remain visible. The editable element may be saved in the standardized digital editing format or the user specified format. The user can also export the editable output file (not shown) to a specified destination such as a hard drive or send the video or notification of its completion to one or more recipients.

Exemplary saving options also include writing of variables from (e.g. the interface method variables) the timeline to a file (e.g. an XML file). Upon playback, the file would be read and the requisite files opened to simulate a single movie playback. The files may remain in the editable format without ever creating a file that combines the various segments. A second option would be for the host application to use those variables and edit the editable elements to write a new binary edited output file to the file system in a common format, e.g., avi, MPEG, or QuickTime. A third option would be to use those variables or data to stitch together multiple clips into a common format e.g., avi, MPEG, or QT. Finally, the user may quit the application 16.

A user may, for example, access the system of the present invention while using a Pentium III or higher level computer, with a Windows 2000 operating systems or higher. Additionally, the computer may e.g. have a capacity of 128 MB RAM and 1000 megahertz processor. Further, the screen resolution is preferably at least 1024×768. These capabilities may exist in personal computers, handheld devices such as the Palm Pilot or Blackberry, and cellular telephones.

As described in U.S. Pat. No. 7,124,366, a typical computer system may include a processor that is connected to a memory system through an interconnection mechanism. The computer may also have a special purpose processor that may be used for performing special functions such as encoding or decoding data or complex mathematical or graphic operations.

The particular language in which the software for the present invention may be programmed includes but is not limited to C, Java and the host application. Through this software, the computer talks to an application such as the media conversion method, directed reading and writing of files such as XML files, and reading of the hard drive or video library.

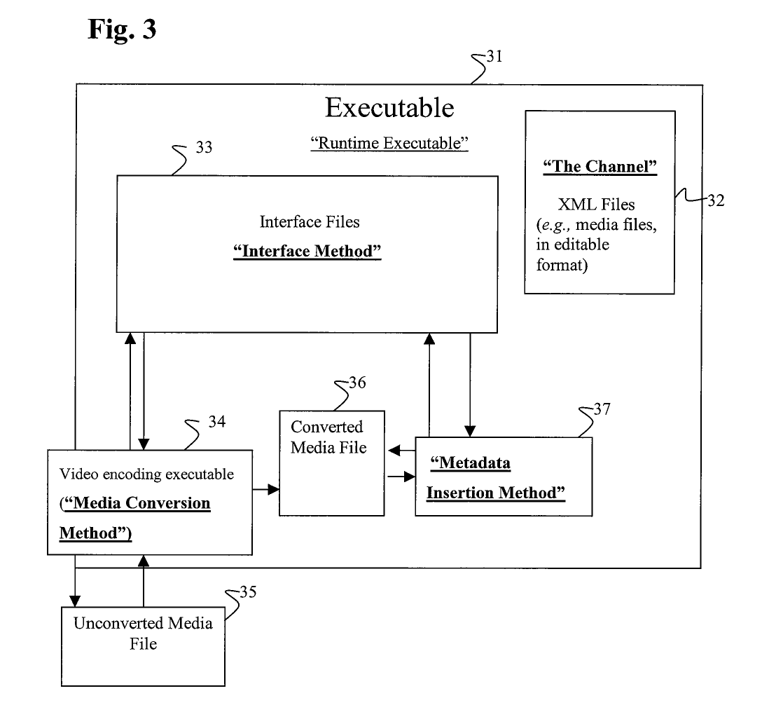

An example of an embodiment of the present invention may be understood by reference to FIG. 3. As seen in the figure, the host application 31 may execute the interface method and the channel and be populated with XML files. When instructed, the interface method 33 activates the media conversion method 34 through a video encoding executable application. Through this method, unconverted media files are accessed and retrieved 35 from e.g., a hard drive. The video encoding executable applicable forms a converted media file 36. To the converted media file metadata may be inserted through the metadata insertion method 37. The metadata insertion method may act upon the converted media file multiple times and then may be called back by the interface file to for example, be saved or shared.

Simultaneously, the channel 32 may load XML files that are either stored within the application or downloaded from a remote server. The channel may be populated with media files that are in an editable format.

After a file is converted, the host application, re-reads directory structure and writes the XML files based on the contents of the directories. It then reloads the interface method, which reflects the presence of the new media files.

Another exemplary embodiment of the invention is to be described in more detail below. This embodiment describes: (I) downloading of the host application; (II) installing the host application; (III) launching of the application; (IV) importing a new media file; (V) selecting media from a media list; (VI) playing and pausing media; (VII) adding effects to media; (VIII) editing the media file using begin/end slider; (IX) adding a media file to the timeline; (X) adding transitions to the timeline; (XI) playing and pausing the edit mode; (XII) saving the edited media; and (XIII) sharing media and edited output files.

I. Download Host Application

The user downloads a host application using HTTP or FTP from a website using a standard web browser or FTP client.

II. Install Host Application

Installation is handled by an application such as Windows OS executable that is created with an installer such as the Nullsoft Scriptable Installer. The installer puts the host application and the support files into pre-set directories on the user's hard drive. The support files may include, but are not limited to: a method for encoding the multimedia files (media conversion method), a method for upgrading the user's application to an appropriate version of the interface method graphic user interface files, and a shortcut to the application on the user's desktop, etc. The host application can be launched from the installer and the host application can run on any appropriate computer, e.g., Windows Personal Computer including but not limited to those running Windows 2000, 2003, Me or XP, Vista or Apple computers running an Apple operating system.

III. Launch Application

When the host application is launched, it checks dependencies. For example it may: (i) detect whether there is an Internet Connection, and if present, downloads assets; (ii) read a library directory in local file system—the library directory may e.g. contain media files (Video, Audio and Image); (iii) write a library XML File to a local file system consisting of relevant file information (e.g., name, type, size, path); (iv) check for the presence of Internet connection and if available connect with remote server using HTTP or HTTPS and request advertisements and/or other information; (v) check for presence of external resources (e.g., media conversion method, the metadata insertion method); and (vi) load a file such as a “Master” interface method (GUI interface) into the host application window as an ActiveX object.

The graphic use interface, e.g., “Master” the interface method file GUI calls a function e.g. XMLLOADER Function, which creates an XML Object and loads a library file such as a XML File. The “Master” interface method file GUI displays a visual library list of available files with thumbnails.

IV. Import New Media File

The import step allows for the conversion and import of a chosen media file into a standard format (e.g., FLV, MP3, JPEG, PNG or GIF) that can be used by the host application and the graphical user interface to preview, playback, manipulate, edit, save and share. By way of a first example, a user may choose Selects File/Import from the host application menu. In the host application, an function for importing files, e.g., <<ImportFile>> function may be called when <<Import>> is selected from application file menu and calls the <<ImportFile>> function. By way of another example, the user may clicks an “Import Button” present in the interface method's graphic user interface. When <<Import>> is selected, a function such as .fscommand may be called. The host application receives the command and directs it to the <<ImportFile>> function.

Next, the file may be processed. Under a first exemplary processing case, the media file is a video and the host application launches <<Choose File Dialog Box>> (or other application to choose the file), checks for acceptable format for importing (e.g., MOV/QuickTime, AVI, MPEG), determines an output file name based on pre-determined naming convention and existing files in library directory and determines the input file path. Through use of, for example, the media conversion method, transcoding is accomplished. FFMPEG may be called via command line to transcode video file from an input format to output format with parameters. An application may be called via a command line to transcode the video file from an input format to output format with parameters.

Following transcoding, one or more, and preferably all of the following parameters may be defined: (i) name; (ii) input file path; (iii) size and aspect ratio; (iv) frame rate; (v) video format; (vi) audio format; (vii) data rate; and (viii) output file path. The above parameters are then used to transcode and save a file such as the editable format file to the users library directory where it will be available to the host application and the interface method's GUI. A thumbnail image (JPEG or PNG) is also generated from a single frame of the imported media file.

Next an application such as the metadata insertion method may be called via a command line to inject meta data (e.g., video duration) into newly transcoded file.

Under a second exemplary processing case, the media file may be audio. In this case, the host application: (i) launches <<Choose File Dialog Box>>; (ii) checks for acceptable format for importing (MP3); and (iii) transfers the chosen file into a library directory.

Under a third exemplary processing case, the media file is an image, and the host application: (i) launches <<Choose File Dialog Box>>; (ii) checks for acceptable format for importing (e.g., JPEG, PNG or GIF); and (iii) transfers the chosen file into library directory.

Following processing, the host application may then re-write the library file, (e.g.) XML file to reflect the new files in the library directory; and load another hidden file such as “Load Method” file. The interface method (or another application serving the same function) may then call the XML LOAD Method Function and send the result to the “Master” through e.g., the Interface Method Connection Method.

V. Select Media From Library List

In the interface method, clicking on icons or a tool bar such as a media file name or thumbnail loads the selected media file from local file system into a media preview area. One of the three exemplary cases below may be chosen based on the media type of file.

Under a first exemplary case for selecting media, the media type is a video file (e.g., the editable format). An application such as the interface method may create a new empty file to store the editable element (e.g., a file denoted “Movie Object”) into which it loads the video file (e.g., the editable format) by creating appropriate parameters, through e.g., a new NetConnection and NetStream Object and giving those objects the path to the editable format file, e.g., FLV.

Under a second exemplary case for selecting media the selected media type is an image file (JPEG or GIF). In this case, the interface method may create a new empty file (e.g., Image Object) into which it loads the image file using a function such as “Load Method.”

Under a third exemplary case for selecting media, the selected media type is an audio file (e.g., MP3). In this case, an application such as the Interface Method creates a new sound object into which it loads the audio file by giving the sound object the path to the audio file.

VI. Play And Pause Media

If the loaded media file is a editable element, a button or icon to play the clip, (e.g., “play clip” button) may be present. Clicking the “play clip” button plays the editable element in the preview area by starting the play method of the interface method. The play method is paused if the user clicks the “play clip” button again.

VII. Add Effects to Media

In the interface method, the user can apply an effect to the currently selected media file by selecting an effect from an effects library. The effects include, but are not limited to: (i) change color and opacity; (ii) change position, scale and orientation; (iii) add text overlay; and (iv) volume. The values of the effects may be saved as a property of the media file.

VIII. Edit Media File Using Begin/End Sliders

If the loaded media file is an editable element, clicking and dragging sliders can change the duration of the element, e.g., Begin/End Sliders sets can be used to begin and end (start and stop) property variables for the current editable element based on the sliders' positions relative to the editable element's duration.

IX. Add Media File to Timeline

The user can add media to the timeline to create a new composition or add to a composition on which the user is working.

X. Add Transitions to Timeline

The user may add transitions in the timeline that create desired effects between media that appear in sequence. These transitions include, but are not limited to, fade in and fade out and overlaying/crossfade.

XI. Play and Pause Edited Movie

Clicking a “play movie” button may in certain applications, (e.g., the interface method) hide the media preview area and play the contents of the timeline. The application then causes each piece of media to playback in order. Playback of each media is a compilation of all effects and transitions that are in the current frame. If the media is a video, then the application seeks the correct point in the media (e.g. NetStream Object) that corresponds with the begin point and plays until the end point is reached. If the media is audio or an image, the application uses a timer to play the media for the appropriate time. The media or the timer is paused if the user clicks the play movie button again.

XII. Save Edited Output Files

Saving an edited output file allows the user to store his or her progress on a particular project between edit sessions and to share finished edited output files with others. Under a first exemplary case for saving an edited output file, the user selects an option for saving the file e.g., <<File/Save>> from the host application menu. In the host application, when save is chosen from the file menu, host application causes a function (e.g., .fscommand) to be called and all edit decisions (e.g., the interface method's timeline variables) are sent to the host application.

Under a second exemplary case for saving an edited output file, the user clicks a save movie button in e.g., the interface method GUI. In the interface method, a function is called and all edit decisions (the interface method Timeline Variables) are sent to the host application.

The methods that the application uses to save include but are not limited to saving to an edit decision list XML file and saving to a host application and a function such as the media conversion method or an equivalent. For example, when saving to an edit decision list XML file, the host application may write timeline variables to an XML file based on SMIL format. Upon playback, the XML file would be read and the requisite media files opened to simulate a single movie playback. Media files remain in the editable format or comparable format, and single movie is never created.

By way of an alternative example, when employing a host application and a function such as the media conversion method, the host application may use the media conversion method, or equivalent to convert media files to a common format (e.g., MOV/QuickTime, AVI, MPEG). The host application or the media conversion method may then use the edit decision list to edit and stitch together media files to form a new binary video file and to write it to local file system in a common format.

XIII. Share Media And Edited Output File

A user may share media and edited output file in many different ways. For example, a user may upload to a website. Accordingly, the host application and graphic user interface such as the interface method make it possible to login and import the user's media and edited output file to video sharing sites or the user's own web site directly by utilizing video sharing sites API's, FTP and/or HTTP. Video sharing sites and requisite authentication information could be added by a user or come pre-installed in the application.

Alternatively, the user may e-mail the edited output file. The host application and a graphic user interface such as the interface method make it possible to compose emails and attach media and edited output file.

In still another alternative, sharing may be done peer-to-peer in which the host application and a graphic user interface such as the interface method make it possible to share media and edited output file through a peer to peer network established when the user is running the host application.

In some embodiments, it is preferable to have a channel. As noted above, the channel in an interface comprised of elements that may be delivered from a specific Internet location. The user may, through the channel, interact with that Internet location, by for example, receiving notifications of up-coming events, promotion and contests, receiving coupons or receiving alerts that another user is on-line. The channel may be capable of communication and activity wholly at separate from the rest of the interface method and has the ability to download or to upload data in real-time.

The programs of the present invention may be configured to display preprogrammed information in the channel at periodic or random intervals, and/or when the user is not on-line.

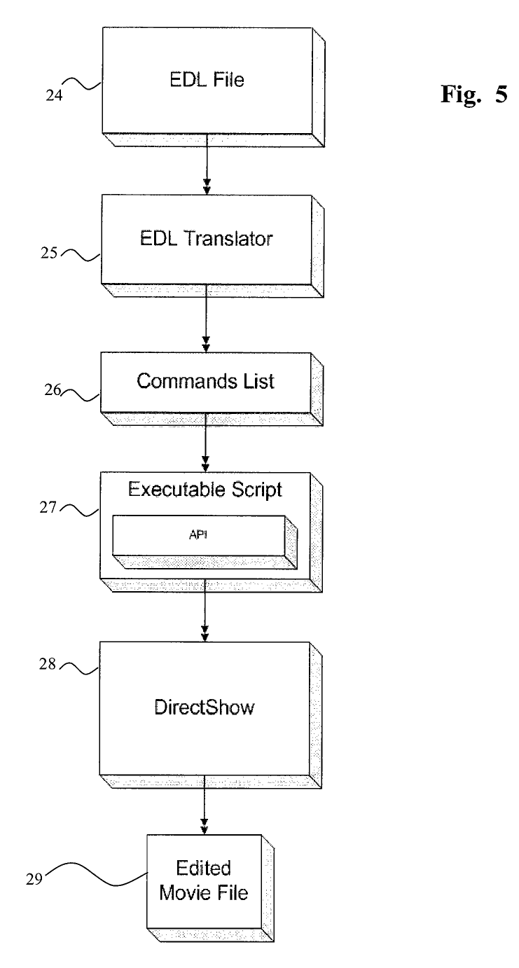

An exemplary method for saving a movie that has been edited may be described by reference to FIG. 5. A user activates an interface module, which is a module within the edit module that enables a user to initiate the save protocol. The interface module gets properties from objects stored in memory that have been created by the user by using the GUI, 24. Properties are saved as formatted text (hereinafter referred to as an “EDL file”) to memory, or to file. These properties may consist of dimensions, start times, stop times, location of original media file, etc. The properties describe the elements in the editable format that define the video, as well as media elements such as transitions, titles, etc., and thus, the EDL is a summary of the properties of the objects. The properties of the media elements are read from memory of the media elements prior to conversion to a standard editable format. Thus, the EDL file may be created by obtaining properties from a plurality of different file types.

The EDL file is passed to a conversion program (“EDL Translator”) 25. A conversion program will convert the properties to commands readable by the executable (“Translation”) application. The commands conform to the known API for the DirectShow and/or AviSynth programs.

A new “commands list” 26 is sent to the “executable script” 27, which executes the API. DirectShow 28 and/or AviSynth accesses the original media files specified in the Commands List to output the Edited Movie File 29 based on the result of the commands in the “Commands List.”

Thus, a user may execute a computer program with instructions and modules that enable a user execute the following methods: (i) import a plurality of media elements, wherein said plurality of media elements are stored in a plurality of file types; (ii) convert said plurality of elements into an editable format; (iii) combine said plurality of elements to form a temporary combined media element; (iv) gather properties of said temporary media element; (v) create a file of said properties; (vi) convert said file of said properties into a set of commands, wherein said commands are readable by an application programming interface; (vii) execute said commands, wherein said executing comprises applying said commands to said plurality of media of elements to form an output media file; and (viii) save said output media file, wherein said output media file comprises a uniform media type.

Any of the features of the various embodiments described herein can be used in conjunction with features described in connection with any other embodiments disclosed unless otherwise specified. Features described in connection with the various or specific embodiments are not to be construed as not suitable in connection with other embodiments disclosed herein unless such exclusivity is explicitly stated or implicit from the context.

We claim:

1. A downloadable computer-based video editing system having a user interface, wherein said computer-based video editing system comprises:
(a) an import module for uploading one or more media elements and converting said one or more media elements into a standardized digital editing format;
(b) an edit module coupled to the import module for editing said one or more media elements when in said standardized digital editing format to form an edited video; and
(c) a share module coupled to the edit module for exporting said edited video to a user specified destination;
wherein said import module, said edit module and said share module are accessible from said user interface and said downloadable computer-based video editing system runs on said user's desktop.

2. The computer-based video editing system of claim 1 further comprising an input device, wherein said input device is selected from the group consisting of a personal computer, a digital camera, a camcorder and a cellular telephone.

3. The computer-based video editing system of claim 2, wherein the input device is connected to the Internet.

4. The computer-based video editing system of claim 1 further comprising a media library, wherein said media library is accessible from said import module.

5. The computer-based video editing system of claim 1, wherein said edit module functions in an integrated development environment.

6. The computer-based video editing system of claim 1, wherein said user specified destination is a hard drive.

7. The computer-based video editing system of claim 1, wherein said user specified destination is a web-site.

8. The computer-based video editing system of claim 1, wherein said user specified destination is one or more e-mail accounts.

9. The computer-based video editing system of claim 1, wherein said user specified destination is a cellular telephone.

10. The computer-based video editing system of claim 1, wherein said user interface does not comprise a toolbar.

11. The computer-based video editing system of claim 1, wherein said computer-based video editing system is remotely accessible.

12. The computer-based video editing system of claim 1, wherein said computer-based video editing system comprises a module for accessing remote servers.

13. The computer-based video editing system of claim 1, wherein said computer-based video editing system is accessible over the Internet.

14. The computer-based video editing system of claim 1 further comprising an alert module for receiving communications, wherein said alert module is coupled to said edit module.

15. The computer-based video editing system of claim 1, wherein said edit module comprises means to edit said one or more media elements in at least one of the following ways: linking two or more videos together, adding an audio overlay, adding digital images, inserting a title sequence, cropping video segments, digitally altering the size of video segments, altering the color of video segments, inserting text, adding special effects and inserting videos within videos.

16. The computer-based video editing system of claim 1 further comprising an alert module, wherein said alert module comprises a channel that is configured to receive and to display content received from a remote computer.

17. A method for editing videos comprising:
(a) accessing a user interface, wherein said user interface provides access to an import module, an edit module and a share module, wherein said edit module is coupled to said import module and said share module;
(b) uploading one or more media elements in a first format and converting said one or more media elements into a standardized digital editing format, wherein said uploading and converting are initiated by activating said import module;
(c) editing said one or more media elements by using said edit module, wherein said editing occurs while said one or more media elements are in said standardized digital editing format to form an edited video; and
(d) sharing said one or more media elements by using said share module to convert said edited video into a user specified format and exporting said video in said user specified format.

18. The method according to claim 17, wherein said accessing is through one or more input devices selected from the group consisting of a computer, a camera, a camcorder and a cellular telephone.

19. The method according to claim 17, wherein said user interface comprises icons through which to access said import module, said edit module, and said export module.

20. The method according to claim 17, wherein said uploading is from a video library.

21. The method according to claim 20, wherein said video library is accessible through the Internet.

22. The method according to claim 17, wherein said editing comprises one or more of the following activities: linking two or more videos together, adding an audio overlay, adding digital images, inserting a title sequence, cropping video segments, digitally altering the size of video segments, altering the color of video segments, inserting text, adding special effects and inserting videos within videos.

23. The method according to claim 17, wherein said user specified format is the same format as the first format.

24. The method according to claim 17 further comprising notifying a group of one or more recipients of said edit video.

25. The method of claim 17, wherein said exporting comprises sending a copy of said video to a group of one ore more recipients.

26. The method of claim 17, wherein said exporting comprises saving to a hard drive.

27. A computer readable storage medium for storing instructions that when executed by a computer, cause the computer to access a computer-based video editing system, wherein said computer-based video editing system comprises:
(a) an import module for uploading one or more media elements and converting said one or more media elements into a standardized digital editing format;
(b) an edit module coupled to the import module for editing said one or more media elements when in said standardized digital editing format to form an edited video; and
(c) a share module coupled to the edit module for exporting said edited video to a user specified destination,
wherein said import module, said edit module and said share module are accessible from the same interface.

28. A method for creating multimedia file, wherein said method comprises:
(a) importing a plurality of media elements, wherein said plurality of media elements are stored in a plurality of file types;
(b) converting said plurality of elements into an editable format;
(c) combining said plurality of elements to form a temporary combined media element;
(d) gathering properties of said temporary media element;
(e) creating a file of said properties;
(f) converting said file of said properties into a set of commands, wherein said commands are readable by an application programming interface;
(g) executing said commands, wherein said executing comprises applying said commands to said plurality of media of elements to form an output media file; and
(h) saving said output media file, wherein said output media file comprises a uniform media type.
